(19) United States
(12) Patent Application Publication
(10) Pub. No.: US 2026/0037902 A1
(43) Pub. Date: Feb. 5, 2026

(54) ADVICE PLANNER

(71) Applicant: INTUIT INC., Mountain View, CA (US)

(72) Inventors: Daniel Ben DAVID, Mountain View, CA (US); Kenneth Grant YOCUM, Mountain View, CA (US); Immanuel David BUDER, Mountain View, CA (US); Martijn DE VRIES, Mountain View, CA (US)

(73) Assignee: INTUIT INC., Mountain View, CA (US)

(21) Appl. No.: 18/791,172

(22) Filed: Jul. 31, 2024

(51) Int. Cl. G06Q 10/0639; G06F 3/04817; G06F 3/0484; G06F 40/40

(52) U.S. Cl. CPC G06Q 10/06393; G06F 3/04817; G06F 3/0484; G06F 40/40

(57) ABSTRACT

At least one processor may receive an advice of a user. The at least one processor may generate a first health score of the advice state. The at least one processor may determine a first action by optimizing a likelihood of improving the first health score, wherein the first action is one of a plurality of actions in an advice library. The at least one processor may generate an action plan including the advice state and the first action. The at least one processor may generate a second health score responsive to the selection. The at least one processor may be trained based on the second health score.

### BACKGROUND

Advice systems are software platforms or tools designed to provide guidance, recommendations, and knowledge to users based on machine learning, data analysis, and domain expertise.

Current advice systems often suffer from several shortcomings that limit their effectiveness and user satisfaction. These systems typically provide generic or one-size-fits-all advice, which fails to address the specific needs and circumstances of individual users. As a result, users may receive irrelevant or impractical recommendations that do not align with their personal situations and aspirations.

Existing advice systems often lack the capability to adapt and learn from user interactions and feedback. They rely on static models or predefined rules, which hinder their ability to evolve and improve over time. Consequently, the advice provided may become outdated or fail to keep up with changing conditions.

Additionally, many advice systems struggle with generating comprehensible advice in a user-friendly manner. The advice may be presented in technical or complex jargon, making it difficult for non-experts to understand and act upon the recommendations effectively. This lack of clear communication can lead to confusion and mistrust, diminishing the value of the advice and the overall user experience.

### BRIEF DESCRIPTIONS OF THE DRAWINGS

FIG. 1 shows an example advice planner system according to some embodiments of the disclosure.

FIG. 2 shows an example planning process according to some embodiments of the disclosure.

FIG. 3 shows an example action calculation process according to some embodiments of the disclosure.

FIG. 4 shows an example training process according to some embodiments of the disclosure.

FIG. 5 shows an example planning process according to some embodiments of the disclosure.

FIG. 6 shows an example computing device according to some embodiments of the disclosure.

### DETAILED DESCRIPTION OF SEVERAL EMBODIMENTS

Embodiments described herein may provide automated systems and methods that can generate advice plans for a company. For example, disclosed embodiments may use one or more machine learning (ML) techniques to provide advice for a company based on characteristics of the company and the health of the company. Disclosed embodiments may determine which advice to provide and create customized advice plans that include advice for reaching a goal of the company. For example, the goal of a company can be long-term profitability. As a result, a company can obtain advice specific to the company that can help the company meet its goals.

Currently, advice systems generally lack the ability to adapt and learn from user interaction. Thus, the advice systems are not providing personalized advice, but rather generic advice that may be good advice in general, but potentially bad advice for the particular user. Therefore, the present disclosure provides an advice system that maps advice actions to a user's advice state and/or problem and is also trained on the selection of the user. As such, the advice system is continuously learning what actions are good for specific users, and thus, the system is personalized. This provides a user experience that optimizes the advice for the benefit of the particular user.

The disclosed embodiments can provide the advice by optimizing a health score of a company to match advice actions to a state of a company. Based on a first health score, an advice planner can select an advice action that optimizes a likelihood of improving the health score. When the selected action is performed, for example by a specific user, the state of the company can change. The advice planner can determine a second health score to determine if the health of the company improved or deteriorated. The advice planner can use ML elements trained so that the actions and/or scores are personalized to the specific user. In some embodiments, the advice action may be chosen at random a percentage of the time to train the advice planner to select advice actions in an unbiased way.

As a specific, non-limiting example, some embodiments may be used in connection with accounting software. In some cases, a user may have a company that may be suffering and not performing as well as desired. To address these issues, some embodiments described herein can provide a customized product which can provide advice on how to meet a goal. The product can be customized based on ML feedback learning such that each selection of advice suggested can improve the product to provide more customized advice for the specific user.

Examples discussed herein are presented in the context of an advice planner product using estimators to generate an action plan for companies to, for example, improve their long-term profitability. However, it should be understood that the disclosed systems and methods can be used in other contexts and/or with other products and/or queries in similar fashion.

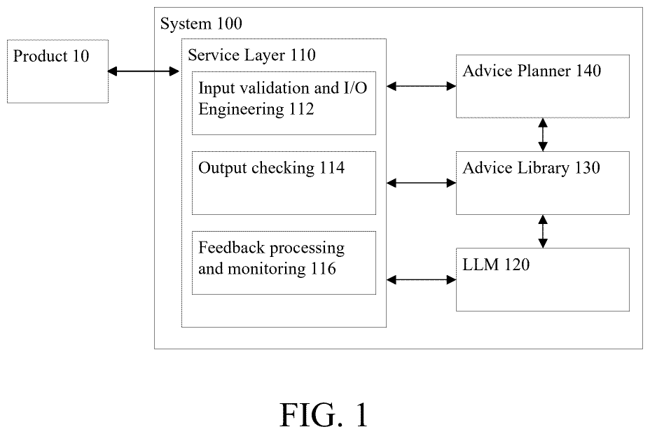

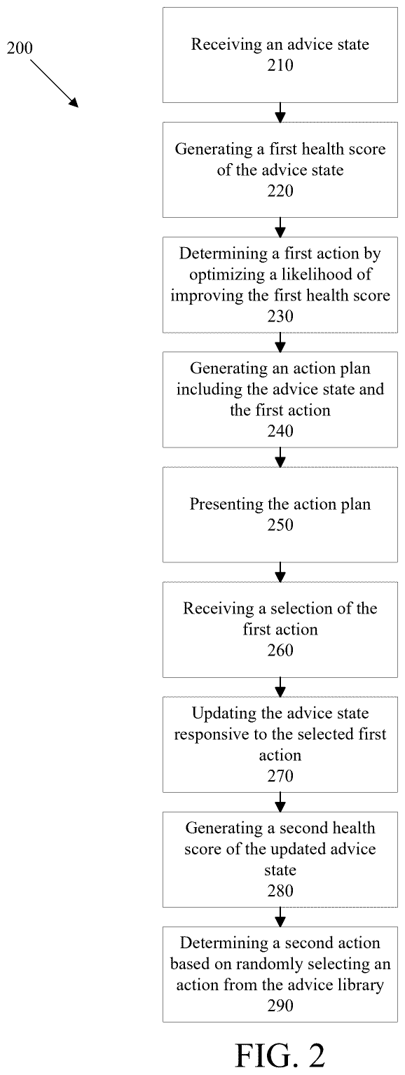

FIG. 1 shows an example advice planner system 100 according to some embodiments of the disclosure. System 100 can be configured to provide personalized advice with ML elements trained on a user's preferences and/or needs. For example, system 100 can perform processing described below with respect to FIGS. 2-5 to provide personalized advice in a variety of situations.

System 100 may include service layer 110, LLM 120, advice library 130, and/or advice planner 140. In some embodiments, LLM 120, advice library 130, and/or advice planner 140 may be components of system 100 (e.g., may be co-located or otherwise coupled with service layer 110), while in other embodiments, LLM 120, advice library 130, and/or advice planner 140 may be separate from service layer 110 (e.g., hosted externally, provided by third parties, etc.) and in communication with service layer 110. Service layer 110 may include input validation and input/output (I/O) engineering module 112, output checking module 114, and/or feedback processing and monitoring module 116, the features and functions of which are described in detail below. In some embodiments, system 100 may include additional modules (not shown) that are commonly included in customer service platforms and/or other modules. As described in detail below, system 100 may interact with product 10, which may be co-located or otherwise coupled with system 100 and/or may be in remote communication with system 100 (e.g., provided by a web server or executed by a client device) to receive query requests, provide query responses, and/or otherwise facilitate interaction between product 10 and LLM 120 and/or advice planner 140.

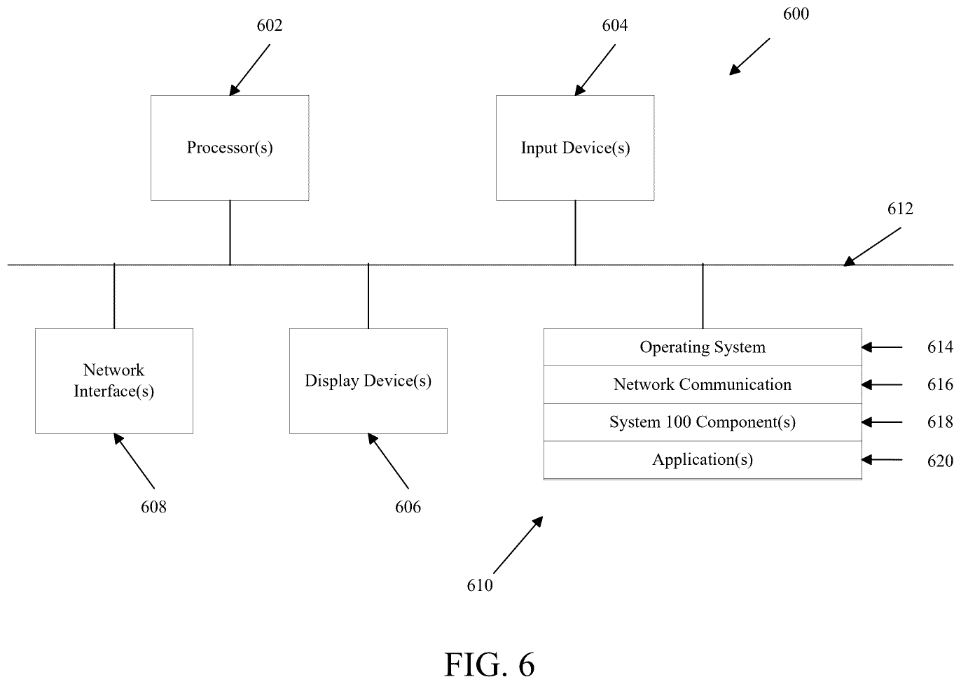

Illustrated components may include a variety of hardware, firmware, and/or software components that interact with one another. Some components shown in FIG. 1 may communicate with one another using networks. For example, product 10 may access system 100 through one or more networks (e.g., the Internet, an intranet, and/or one or more networks that provide a cloud environment). In another example, service layer 110 may use one or more networks to communicate with one or more of LLM 120, advice library 130, and advice planner 140. Each component may be implemented by one or more computers (e.g., as described below with respect to FIG. 6).

The elements of system 100 and functions thereof are described in greater detail below with respect to FIGS. 2-5. but in general, service layer 110 may receive and process queries from product 10, which may include the use of advice library 130, before providing the processed queries to LLM 120 and/or advice planner 140. Service layer 110 may also receive query responses from LLM 120 and/or advice planner 140 and process the responses before providing the processed responses to product 10. Examples of query processing may include, but are not limited to, validating queries, converting queries into structured DB entries, and/or enriching queries. Examples of response processing may include, but are not limited to, validating responses, generating response payloads, and/or storing response data as future context data.

Product 10 may be any software, hardware, firmware, or combination thereof that can use the enhanced query generation and response validation processing of system 100. An example product 10 discussed herein is tax preparation software used by accountants on behalf of client filers, but various other products 10 that include functionality for interfacing with LLMs could be substituted in various embodiments.

Service layer 110, as described in detail herein, can act as a liaison between product 10 and LLM 120 and/or advice planner 140. Product 10 can send natural language queries to service layer 110. Service layer 110 can perform input validation and I/O engineering (e.g., generating an enhanced prompt in a required format with added data such as context data, checking for errors and security issues, sending to LLM 120 and/or advice planner 140). Service layer 110 can check LLM 120 and/or advice planner 140 responses for hallucination and/or appropriateness and, if validation passes, send responses to product 10, or send other messages in the event of validation failure. Service layer 110 and/or other elements of system 100 can perform telemetry, observation, and monitoring processing such as reentering responses into advice library 130 and using the reentered responses as future context to make responses better in the future.

LLM 120 can be any large language model, including off-the-shelf models such as ChatGPT and/or proprietary models. LLM 120 can process queries sent by service layer 110 and send response. In some embodiments, LLM 120 may generate one or more action plans based on an advice state and one or more advice actions selected by advice planner 140.

Advice library 130 can be any advice library database, such as Open Search or other products. Advice library 130 can store data in a standard format, such as query data and/or context data, as described in detail herein.

Advice planner 140 may include one or more estimators. For example, advice planner 140 may include one or more per-item estimators, tree-based estimators, regressors, linear regressors, and/or neural network estimators. In some embodiments, advice planner 140 may include a classifier. Advice planner 140 may be configured to prioritize one or more advice actions for one or more advice states. The prioritization may be based on a likelihood of an advice action to improve one or more advice states. In some embodiments, the likelihood of an advice action to improve one or more advice states may include a determination of how an advice action may change one or more key performance indicators (“KPI”).

In some embodiments, advice planner 140 may include a multilayer commander system architecture. For example, a lower layer may include optimizing an action for a user based on the user's characteristics. The lower layer may use KPI to differentiate across advice states. A KPI may correspond to a specific advice state. An upper layer may include determining the health score based on the actions selected. The determination may include a determination of whether the KPI was changed by the selected action, thus indicating a change in the advice state. The health score may be a reward which indicates to the lower layer whether a selected action was good or bad for the given scenario. A profiling layer may be included to personalize based on a specific user.

Elements illustrated in FIG. 1 (e.g., system 100 (including service layer 110 and its modules (input validation and I/O engineering module 112, output checking module 114, and feedback processing and monitoring module 116), LLM 120, advice library 130, advice planner 140) and product 10) are each depicted as single blocks for ease of illustration, but those of ordinary skill in the art will appreciate that these may be embodied in different forms for different implementations. For example, while separate modules of system 100 are depicted separately, any combination of these elements may be part of a combined hardware, firmware, and/or software element. Moreover, while the modules are depicted as parts of a single system 100 element, any combination of these elements may be distributed among multiple logical and/or physical locations. Also, while one product 10, one system 100 with one service layer 110, LLM 120, advice library 130, and advice planner 140, and one of each module (e.g., input validation and I/O engineering module 112, output checking module 114, and feedback processing and monitoring module 116) are illustrated, this is for clarity only, and multiples of any of the above elements may be present. In practice, there may be single instances or multiples of any of the illustrated elements, and/or these elements may be combined or co-located. For example, system 100 may interact with multiple products 10 and may employ multiple advice planner 140 instances and/or types and/or advice library 130 instances and/or types.

In the following descriptions of how the illustrated components function, several examples are presented, including examples using specific data or data types such as financial data and KPI data. However, those of ordinary skill in the art will appreciate that these examples are merely for illustration, and the disclosed embodiments are extendable to other application and/or data contexts.

FIG. 2 shows an example planning process 200 according to some embodiments of the disclosure. System 100 may perform planning process 200 and thereby provide customized planning in combination with LLM system(s) (e.g., LLM 120) and/or advice planner(s) 140. For example, process 200 can include generating a health score of a company, determining an action by optimizing a likelihood of improving the health score, generating an action plan including the action, receiving a selection of the action, and updating the health score.

At 210, service layer 110 may obtain an advice state of a company from product 10. The advice state may include a problem statement and may provide context to the advice planner 140 for optimizing a solution. For example, the company may be facing a problem, such as an invoicing concern, or may have identified particular goals for growing the company. The advice state may be obtained from a user via a user interface of the product 10. In some embodiments, the advice state may be obtained by the system 100 analyzing the financial situation of a company.

At 220, LLM 120 may generate a health score of the advice state. The health score may be generated by analyzing a company's health overall. In some embodiments, the health score may include a determination of how the company compares to others in certain categories. In some embodiments, the health score may be determined by analyzing the company financial situation. The health score can be a continuous value score such that a company can be evaluated across advice states.

At 230, advice planner 140 may determine an action by optimizing a likelihood of improving the health score. The action can be selected from advice library 130. Advice planner 140 may determine one or more actions from advice library 130 that may improve the health score. In some embodiments, advice library 130 may store actions that are associated with one or more advice states, such that the actions may be grouped based on which advice states they affect. Advice planner 140 may use a policy to map one or more actions from advice library 130 to the advice state context. In some embodiments, the policy may be one of deterministic or stochastic. Advice planner 140 may determine a likelihood of each action to improve the health score and/or move the user out of the current advice state and may select an action with the highest ranked likelihood. In some embodiments, advice planner 140 may select one or more actions to suggest to the user. Advice planner 140 may use a cumulative regret function which may measure the difference in loss between the action selected by the policy and an optimal action available given the context. The optimal action may be determined by a policy configured to select an action which minimizes the expected loss given a particular context. Advice planner 140 may be updated based on the regret function such that, over time, the regret function may be minimized.

At 240, LLM 120 may generate an action plan including the advice state and the one or more actions. The action plan may include an explanation of how the action changes the advice state and/or improves the health score. In some embodiments, the action plan may include a comparison of the user with competitors.

At 250, service layer 110 may present the action plan to the product 10. The action plan may be presented on a user interface of the product 10 and may allow for selecting of the action. The action plan may include a graphical icon representing the action. This enables the user to interact with the action. In some embodiments, the action plan may include an option to reject the suggested action. The option to reject the suggested action may be represented by a graphical icon included on the user interface. For example, the user may decide to not perform the suggested action, in which case, the advice planner 140 may update the policy to not present the action for the corresponding advice state of the user. In some embodiments, system 100 may repeat steps 230 and 240 until the user selects an action.

At 260, service layer 110 may receive a selection of the action from the product 10. The selection may be received via a user interface of the product 10.

At 270, LLM 120 may update the advice state responsive to the selected action. LLM 120 may determine whether the selected action moved the user out of the previous advice state and into a new advice state, or whether the selected action kept the user in the previous advice state. The determination may be based on the LLM analyzing the KPI of the user after performing the selected action. For example, if the original advice state is Getting Paid, as a company has not been getting paid for invoices sent out, the action may be sending invoice reminders. If taking the action results in more invoices being paid, the KPI of the company would improve, which may indicate a changed advice state.

At 280, LLM 120 may generate a health score of the updated advice state. The health score may be generated by analyzing a company's overall health. In some embodiments, the health score can be generated by analyzing the KPI of the company as the KPI may correspond to specific advice states. The analyzed KPI may indicate whether the selected action moved the company to a different advice state. An improved advice state may correspond to a higher health score as the overall health may have improved. For example, if the original advice state was Getting Paid, the action may be sending invoice reminders. If taking the action results in more invoices being paid, the advice state would change, and the health score would be increased as more money is coming in.

At 290, advice planner 140 may determine an action by randomly selecting an action from the advice library 130. The determination may be performed by an Epsilon-Greedy function. Advice planner 140 may include a policy to randomly select an action a certain percentage of the time such that the advice planner 140 may learn in an unbiased way. In some embodiments, the policy may randomly select an action about 20% of the time.

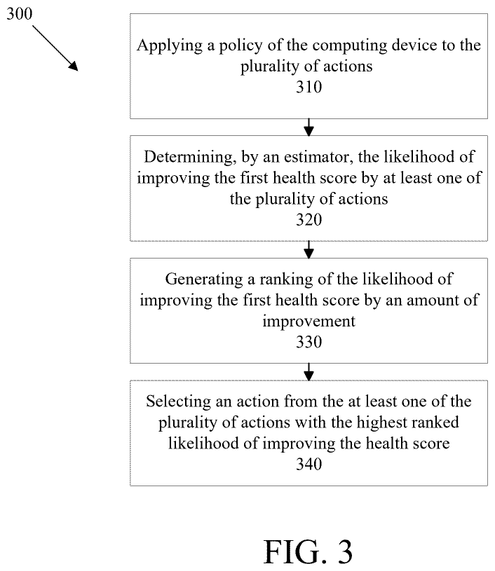

FIG. 3 shows an example optimization process 300 according to some embodiments of the disclosure. System 100 may perform optimization process 300 and thereby provide customized optimization in combination with advice planner(s) 140. For example, process 300 may include applying a policy to a plurality of actions, determining the likelihood of improving a health score by at least one of the plurality of actions, generating a ranking of the likelihood of improving the health score by an amount of improvement, and selecting an action from the at least one of the plurality of actions with the highest ranked likelihood of improving the health score.

At step 310, advice planner 140 may apply a policy to the plurality of actions in the advice library 130. At least one of the plurality of actions may be selected by mapping the advice state context to the plurality of actions in the advice library 130.

At step 320, advice planner 140 may determine the likelihood of improving the health score by at least one of the plurality of actions. Advice planner 140 may use an estimator to perform the determination. The estimator may be a per-item estimator. In some embodiments, the estimator may be one of a tree-based estimator, a regressor, a linear regressor, and a neural network estimator. The goal of the policy may be to change the advice state. Thus, advice planner 140 may seek to determine the action that is most likely to change the advice state. This may correspond to the action most likely to change the KPI.

At step 330, advice planner 140 may generate a ranking of the likelihood of improving the health score by an amount of improvement. The ranking may be determined based on the predicted effect of the actions on the KPI of the user. A predicted improvement of the KPI may indicate moving out of the current advice state, which may improve the health score. An amount of improvement may be predicted by analyzing the predicted improvement of the KPI and the predicted updated advice state.

At step 340, advice planner 140 may select an action from the at least one of the plurality of actions with the highest ranked likelihood of improving the health score. Advice planner 140 may choose the action most likely to change the advice state of the user.

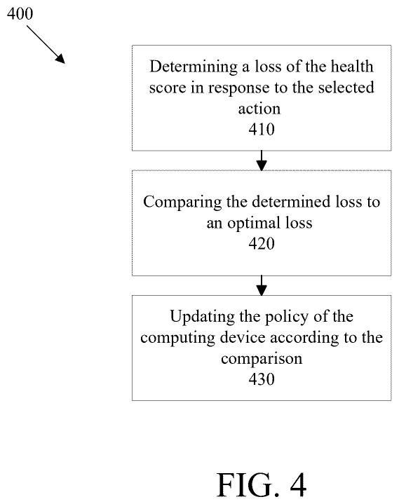

FIG. 4 shows an example training process 400 according to some embodiments of the disclosure. System 100 may perform training process 400 and thereby provide customized training in combination with LLM system(s) (e.g., LLM 120) and/or advice planner(s) 140. For example, process 400 may include determining a loss of the health score in response to the selected action, comparing the determined loss to an optimal loss, and updating the policy according to the comparison.

At 410, LLM 120 may determine a loss of the health score in response to the selected action. The loss may correspond to an improvement of the KPI and moving out of the advice state. For example, a large loss may indicate no improvement in the KPI and staying in the advice state while a small loss may indicate an improvement in the KPI and moving out of the advice state. In some embodiments, the goal of the policy may be to minimize the loss of the health score. A minimal loss may correspond to the optimal action given a particular context. The optimal action may correspond to the greatest improvement of the health score and moving out of the current advice state.

At 420, LLM 120 may compare the determined loss to an optimal loss. The optimal loss may be the minimal loss. Thus, while the goal of the policy may be to minimize the loss, the determined loss may be greater than the optimal loss. This may correspond to an action that may be less than optimal being selected.

At 430, advice planner 140 may update the policy of the advice planner 140 according to the comparison. The comparison of the determined loss with the optimal loss may indicate to the advice planner 140 how far the selected action was from being an optimal action. The policy may be updated based on the health score using reinforcement learning with the health score as the reward to the advice planner 140. For example, if the health score improves in response to an action, feedback is provided to advice planner 140 that a good action was selected. Advice planner 140 may update the policy to set a relevance score between the selected action and the current advice state. In operation, advice planner 140 may begin to converge to the optimal action over time as advice planner 140 learns relevance between the actions and the advice states based on the feedback of the health score. Thus, advice planner 140 may increasingly match good actions to the advice states.

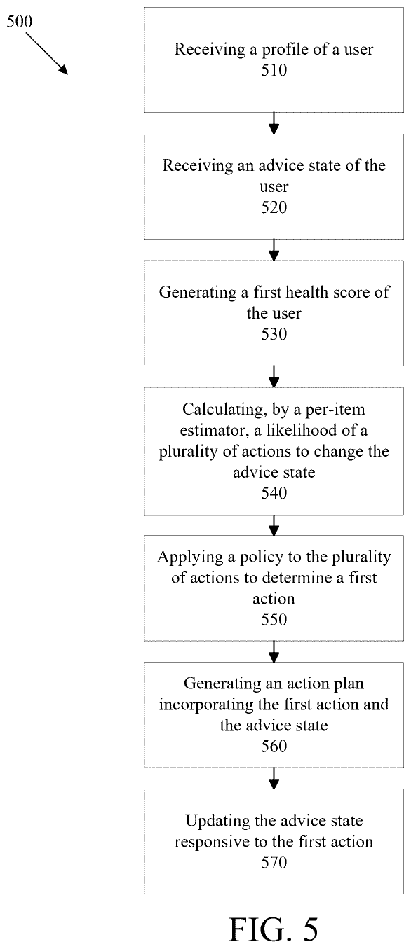

FIG. 5 shows an example process 500 according to some embodiments of the disclosure. System 100 may perform planning process 500 and thereby provide customized planning in combination with LLM system(s) (e.g., LLM 120) and/or advice planner(s) 140. For example, process 500 may include receiving a profile of a user, receiving an advice state of the user, generating a health score of the user, calculating a likelihood of a plurality of actions to change the advice state by a per-item estimator, applying a policy to the plurality of actions to determine an action, generating an action plan incorporating the action and the advice state, and updating the advice state responsive to the action.

At 510, service layer 110 may receive a profile of a user company. Service layer 110 may receive the profile via the product 10 user interface. The profile may include financial information. Service layer 110 may gather user data, for example by receiving data entered by a user into one or more fields, data from one or more files uploaded by the user, data from third-party or external sources identified by the user, and/or other sources.

At 520, service layer 110 may receive an advice state of the user company. The advice state may include a problem statement and may provide context to the advice planner 140 for optimizing a solution. For example, the company may be facing a problem, such as an invoicing concern, or may have identified particular goals for growing the company. The advice state may be obtained from a user via a user interface of the product 10. In some embodiments, the advice state may be obtained by the system 100 analyzing the financial situation of a company.

At 530, LLM 120 may generate a health score of the user. The health score may be generated by the LLM 120 analyzing the profile along with the advice state. The health score may be generated by analyzing a company's health overall. In some embodiments, the health score may include a determination of how the company compares to others in certain categories. In some embodiments, the health score may be determined by analyzing the company financial situation. The health score can be a continuous value score such that a company can be evaluated across advice states.

At 540, advice planner 140 may calculate a likelihood of a plurality of actions to change the advice state by a per-item estimator. The action can be selected from advice library 130. Advice planner 140 may determine one or more actions from advice library 130 that may improve the health score. In some embodiments, advice library 130 may store actions that are associated with one or more advice states, such that the actions may be grouped based on which advice states they affect. The estimator may be one of a per-item estimator, a tree-based estimator, a regressor, a linear regressor, and a neural network estimator. The likelihood may be calculated by predicting an expected loss of the health score responsive to an action. In some embodiments, minimizing the loss may correspond to changing the advice state. In some embodiments, advice planner 140 may select one or more actions to suggest to the user. Advice planner 140 may use a cumulative regret function which may measure the difference in loss between the action selected by the policy and an optimal action available given the context. The optimal action may be determined by a policy configured to select an action which minimizes the expected loss given a particular context.

At 550, advice planner 140 may apply a policy to the plurality of actions to determine an action. The policy may determine which of the actions to suggest based on the likelihood of the actions to change the advice state. Advice planner 140 may use a policy to map one or more actions from advice library 130 to the advice state context. In some embodiments, the policy may be one of deterministic or stochastic. Advice planner 140 may determine a likelihood of each action to improve the health score and/or move the user out of the current advice state and may select an action with the highest ranked likelihood. In some embodiments, advice planner 140 may select one or more actions to suggest to the user. Advice planner 140 may use a cumulative regret function which may measure the difference in loss between the action selected by the policy and an optimal action available given the context. The optimal action may be determined by a policy configured to select an action which minimizes the expected loss given a particular context. Advice planner 140 may be updated based on the regret function such that, over time, the regret function may be minimized. In some embodiments, the policy may include a random determination of an action a certain percentage of the time. For example, the policy may choose a random action about 20% of the time and choose an action based on the likelihood of the actions to change the advice state about 80% of the time.

At 560, LLM 120 may generate an action plan incorporating the action and the advice state. The action plan may include an explanation of how the action changes the advice state and/or improves the health score. In some embodiments, the action plan may include a comparison of the user with competitors.

At 570, LLM 120 may update the advice state responsive to the action. LLM 120 may determine whether the selected action moved the user out of the previous advice state and into a new advice state, or whether the selected action kept the user in the previous advice state. In some embodiments, the advice state may be updated based on analyzing a determined KPI of the user after performance of the action. The KPI may indicate whether the user changed advice states or remained in the original advice state. For example, if the original advice state is Getting Paid, as a company has not been getting paid for invoices sent out, the action may be sending invoice reminders. If taking the action results in more invoices being paid, the KPI of the company would improve, which may indicate a changed advice state.

FIG. 6 shows a computing device 600 according to some embodiments of the disclosure. For example, computing device 600 may function as system 100 and/or any portion(s) thereof, or multiple computing devices 600 may function as system 100 and/or any portion(s) thereof.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

System 100 components 618 may include instructions for performing the processing described herein. For example, system 100 components 618 may provide instructions for performing any and/or all of processes 300-500, and/or other processing as described above. Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by a computing device, an advice state of a user;
generating, by the computing device, a first health score of the advice state;
determining, by the computing device, an action by optimizing a likelihood of improving the first health score, wherein the action is one of a plurality of actions in an advice library, the determining comprising:
applying a policy of the computing device to the plurality of actions to map at least one of the plurality of actions to the advice state;
determining, by an estimator of the computing device, the likelihood of improving the first health score by the at least one of the plurality of actions;
generating a ranking of the likelihood of improving the first health score by an amount of improvement; and
selecting the action from the at least one of the plurality of actions with a highest ranked likelihood of improving the first health score;
generating, by the computing device, an action plan including the advice state and the action;
presenting, via a user interface, the action plan including a graphical icon representing the action;
receiving, via the user interface, a selection of the graphical icon representing the action;
generating, by the computing device, a second health score responsive to the selection; and
training the computing device based on the second health score.

2. The method of claim 1, wherein the determining the first action further comprises:
generating profile characteristics of the user, wherein the determining the likelihood of improving the first health score is based on the advice state and the profile characteristics.

3. The method of claim 1, wherein the advice library comprises the plurality of actions and a plurality of advice states related to the plurality of actions.

4. The method of claim 1, wherein the plurality of advice states have at least one related key performance indicator, wherein the generating the first health score of the advice state incorporates the at least one key performance indicator.

5. The method of claim 4, wherein the determining the likelihood of improving the first health score comprises predicting a change in the at least one key performance indicator.

6. The method of claim 1, wherein the training comprises:
determining a loss of the second health score in response to the selected action;
comparing the determined loss to an optimal loss; and
updating the policy of the computing device according to the comparing.

7. The method of claim 1, wherein the action is a first action and wherein the graphical icon is a first graphical icon, the method further comprising:
determining, by the computing device, a second action by randomly selecting an action from the advice library;
presenting, via the user interface, a second graphical icon representing the second action;
receiving, via the user interface, a selection of the second graphical icon representing the second action;
updating, via the computing device, the advice state responsive to the second action;
generating, by the computing device, a third health score of the updated advice state; and
training the computing device based on the third health score, wherein the training comprises:
determining a loss of the third health score in response to the selected action;
comparing the determined loss to an optimal loss; and
updating the policy of the computing device according to the comparing.

8. A method comprising:
receiving, by a computing device, a profile of a user;
receiving, by the computing device, an advice state of the user;
generating, by the computing device, a first health score of the user, the first health score incorporating the profile of the user and the advice state;
calculating, by a per-item estimator of the computing device, a likelihood of a plurality of actions to change the advice state;
applying, by the computing device, a policy to the plurality of actions to determine a first action, the policy comprising an Epsilon-Greedy algorithm;
generating, by the computing device, an action plan incorporating the first action and the advice state; and
updating, by the computing device, the advice state responsive to the first action.

9. The method of claim 8, wherein the per-item estimator is a tree-based estimator.

10. The method of claim 8, wherein the plurality of actions are stored in an advice library comprising the plurality of actions and a plurality of advice states related to the plurality of actions.

11. The method of claim 8, wherein the plurality of advice states have at least one related key performance indicator, wherein the generating the first health score of the advice state incorporates the at least one key performance indicator.

12. The method of claim 8, further comprising:
generating, by the computing device, a second health score of the updated advice state; and
training the computing device based on the updated advice state, wherein the training comprises:
determining a loss of the second health score in response to the first action;
comparing the determined loss to an optimal loss; and
updating the policy of the computing device according to the comparing.

13. The method of claim 8, further comprising:
receiving, via a user interface, a goal from the user;
wherein the calculating the likelihood of the plurality of actions to change the advice state incorporates the goal received from the user.

14. A non-transitory storage medium storing computer program instructions that when executed causes a computing system to perform operations comprising:
receiving, by a computing device, an advice state of a user;
generating, by the computing device, a first health score of the advice state;
determining, by the computing device, an action by optimizing a likelihood of improving the first health score, wherein the action is one of a plurality of actions in an advice library, the determining comprising:
applying a policy of the computing device to the plurality of actions to map at least one of the plurality of actions to the advice state;
determining, by an estimator of the computing device, the likelihood of improving the first health score by the at least one of the plurality of actions;
generating a ranking of the likelihood of improving the first health score by an amount of improvement; and
selecting the action from the at least one of the plurality of actions with a highest ranked likelihood of improving the first health score;
generating, by the computing device, an action plan including the advice state and the action;
presenting, via a user interface, the action plan including a graphical icon representing the action;
receiving, via the user interface, a selection of the graphical icon representing the action;
generating, by the computing device, a second health score responsive to the selection;
training the computing device based on the second health score.

15. The non-transitory storage medium of claim 14, wherein the determining the first action further comprises:
generating profile characteristics of the user, wherein the determining the likelihood of improving the first health score is based on the advice state and the profile characteristics.

16. The non-transitory storage medium of claim 14, wherein the advice library comprises the plurality of actions and a plurality of advice states related to the plurality of actions.

17. The non-transitory storage medium of claim 14, wherein the plurality of advice states have at least one related key performance indicator, wherein the generating the first health score of the advice state incorporates the at least one key performance indicator.

18. The non-transitory storage medium of claim 17, wherein the determining the likelihood of improving the first health score comprises predicting a change in the at least one key performance indicator.

19. The non-transitory storage medium of claim 14, wherein the training comprises:
determining a loss of the second health score in response to the selected action;
comparing the determined loss to an optimal loss; and
updating the policy of the computing device according to the comparing.

20. The non-transitory storage medium of claim 14, wherein the action is a first action and wherein the graphical icon is a first graphical icon, the operations further comprising:
determining, by the computing device, a second action by randomly selecting an action from the advice library presenting, via the user interface, a second graphical icon representing the second action;
receiving, via the user interface, a selection of the second graphical icon representing the second action;
updating, via the computing device, the advice state responsive to the selection of the second action;
generating, by the computing device, a third health score of the updated advice state; and
training the computing device based on the third health score, wherein the training comprises:
determining a loss of the third health score in response to the selected action;
comparing the determined loss to an optimal loss; and
updating the policy of the computing device according to the comparing.
